(19) United States
(12) Patent Application Publication
(10) Pub. No.: US 2003/0060539 A1
(43) Pub. Date: Mar. 27, 2003

(54) Liquid glass paint

(76) Inventor: Marc Meire, New York, NY (US)

Correspondence Address: SHAW PITTMAN LLP, 1650 TYSONS BOULEVARD, MCLEAN, VA, 22102, US

(21) Appl. No.: 10/232,311

(22) Filed: Sep. 3, 2002

(30) Foreign Application Priority Data
Sep. 3, 2001 (DE) 20114492.1

(51) Int. Cl. C08K 3/00; C08K 9/10

(52) U.S. Cl. 523/210; 524/589

(57) ABSTRACT

The invention relates to liquid glass paint characterized by the fact that it has been treated with an odor neutralizing substance and/or at least one selected scent.

The invention relates to paint used for painting on glass or on a support sheet, whereby the paint generally is applied as a thin film. The images created from templates are thus usually, at least partially, transparent.

Such liquid glass paints are stored in, for example, plastic bottles that, on the one hand, are sturdy enough to keep their shape and, on the other hand, will yield to pressure in the center area of the bottle allowing the paint to be squeezed out of the bottle. These plastic bottles are fitted with an opening at the top end of the bottleneck to facilitate the application of paint directly unto the glass or a support sheet. The bottle is also fitted with a reusable lid, for example, a screw lid to protect the paints from drying out.

Some of such glass paints often smell unpleasantly because they contain solvents and other additives, in particular when they come into contact with air. The unpleasant odor usually disappears as the liquid paint dries.

Liquid glass paints, of the type described above, gradually dry after application and in the process become so hard that even at the places where different colors touch they do not mix, but will merely attach to each other. The moisture that is released during the drying process is full of, among other things, odorous substances released, for example, from the solvents. The user may consider these odors unpleasant, especially if several people are using glass paints at once in an enclosed area.

Often, these well-known glass paints are used for making decorations that are significant to specific seasons. Before Christmas, for example, the motifs may include candles, decorated Christmas trees or Santa Claus riding on his sleigh.

An observer can only visually perceive the image created using the liquid glass paint. However, the unpleasant odors that are released while the paint is being applied adversely affect the enjoyment of creating the motifs.

Therefore, it is an object of the invention to improve the sensory perceptions of images created using liquid glass paints.

According to the invention, this problem is solved by, in addition to visual perception, facilitating olfactory perception by treating the glass paint with an odor neutralizing substance and/or with at least one selected scent.

It would be particularly advantageous if the scent were to harmonize with the chosen color, in other words if, for example, the color green would smell like pine needles or fir or the color brown would smell like cinnamon or cloves. The substances that produce the corresponding scent could, for example, be scented oils or resins that are mixed into the liquid glass paint. The scent would be mixed into the paint prior to bottling the handicraft paint or as the paint flows out of the bottle, in other words, while the paint is in use. The scented oils, resins or other scented substances used should have a polymer structure that is compatible with the components in the glass paint. In particular, a stable mixture or suspension can exist with the glass paint.

In a preferred embodiment of the invention the paint color is free of solvents. Under such circumstances there is hardly any chance of the occurrence of olfactory interactions with the chosen scent or scent composition.

The invention takes advantage of the fact that pigment is comprised of plastic materials in which specially chosen scented substances can be stored in the matrix. Therefore, it is not necessary to use a separate carrier for holding the scented substances. Furthermore, the matrix will only release the scented substance little by little so that a small room could be scented over a longer period of time by a book that has been painted with the paints according to the invention.

A particular aspect of the invention is that only such scented additives that are compatible with the pigment and which do not lead to precipitation should be used. The pigments are, for example, polyurethane based and have a specific matrix whereby the substances to be stored there are chosen in such a manner that they fit into the matrix and are only later released from there. The correct combination of scent and solvent or carrier system should be chosen in order to regulate the speed of the release of the scents to ensure that the scent can be enjoyed over a period of several days or even several weeks.

Another aspect of the invention is the proportion of mass of scented oil to the volume of glass paint. This problem is solved with the invention when the mass of scented oil (measured in grams) equals 1% to 10% of the glass paint volume (measured in millimeters). In a preferred embodiment of the invention, the proportion is 5%, so for a bottle content of approximately 80 ml of glass paint approximately 4 g of scented oil is added. The amount of scent generating substance added must depend on the volume because only a specific amount of scent should be released per volume of applied paint.

Therefore, the scent should be designed in such a manner that the scent characteristic will remain intact even after having been consistently exposed to air. In a preferred embodiment of the invention, the scent will only volatilize slowly.

According to the invention, the unpleasant smell of the liquid glass paint is neutralized and/or mixed with a pleasantly smelling scent.

The pleasantly smelling scent of the liquid glass paint can be prepared from, for example, scented oils or resins. The advantage of using scented oils is that they are easily mixed with the liquid glass paint.

Often, a particular color is associated with a certain scent. This should be taken advantage of when combining, in a package, a collection of glass paints that have scents that are associated with a certain season such as Christmas, Easter or a certain experience such as baking cookies, the flower garden and so forth.

In one embodiment of the invention, the liquid glass paint in the example is green and smells like fir, pine needles or something similar providing a Christmas tree displayed at Christmas with the additional olfactory effect.

In another embodiment of the invention, the liquid glass paint color is brown and smells like cinnamon or cloves creating a Christmas-like ambiance both while using the paint and while enjoying the finished motif.

A packaged collection of glass paints some of which have scents that are associated with certain themes, products or characters and some of which may be unscented could be produced. Generally, the contour color will remain black and unscented. A “Wellness Set” could, for example, include a blue color that would be given a scent composition called “Active” which will be associated with ocean water, fresh air and exercise, while the color burgundy could contain a scent combination called “Romantic” that would smell like, for example, roses or other flowers. The color green could contain a scent combination called “Energy” that would smell like fruit.

Additional scents that could be used in packaged combinations of glass paint colors could include “Wood” for the color brown, “Sunmilk” for the color yellow, and “Fruit Cocktail” for the color red.

In this manner, it is possible to, for example, give the skin color used on cartoon characters an appropriate scent to enable corresponding associations. For example, the Beast, a character from the animated film, “The Beauty and The Beast”, has red spots on his skin which when represented with glass paint could be scented with a scent combination called “Fruit Cocktail”. The blue dress of the character, the Beauty, could be given a scent called “Seabreeze”.

Each glass paint theme set would include the corresponding templates.

Even though the invention is described in connection with glass paint, it should be stressed that carriers other than glass or a support sheet also could be used. The carrier does not need to be transparent to benefit from the advantages of transparent color film. Another suitable application area could be the interior of motor vehicles, when a carrier made from plastic material, for example, in the shape of a tree, a sailing ship and so forth is painted with the glass paint that contains the appropriate scent compositions. The carrier could be transparent or not, either way a scent is released in the interior of a motor vehicle, as intended. The consumer can choose the motif that will achieve the desired atmosphere.

The characteristics of the invention revealed in the above description, in the drawing, as well as in the patent claims could be significant for the realization of the invention individually as well as in any combination.

1. Liquid paint color characterized by the fact that it has been treated with an odor neutralizing substance and/or with at least one selected scent.

2. Liquid paint color in accordance with claim 1, characterized by the fact that the scent is generated from scented oils or resins.

3. Liquid paint color in accordance with one of the above claims, characterized by the fact that the scents are mixed with the paint prior to bottling.

4. Liquid paint color in accordance with one of claims 1 to 2, characterized by the fact that it is filled into a bottle and the scents are mixed with the paint color as it flows out of the bottle opening.

5. Liquid paint color in accordance with one of claims 1 to 4, characterized by the fact that the scents in the paint color are released as it is exposed to air.

6. Liquid paint color in accordance with one of claims 1 to 4, characterized by the fact that the scents are released as the dried paint warms up.

7. Liquid paint color in accordance with one of claims 1 to 4, characterized by the fact that the scents are released on the dried paint by mechanical means.

8. Liquid paint color in accordance with one of claims 1 to 4 or 7, characterized by the fact that the scents are encapsulated in small pellets or microcapsules.

9. Liquid paint color in accordance with one of claims 1 to 3, characterized by the fact that it is bottled in containers fitted with openings large enough that a paint brush or other similar tool can be inserted into the paint.

10. Liquid paint color in accordance with claim 9, characterized by the fact that the scents are encapsulated into small pellets or microcapsules which have membranes that collapse as pressure is exerted on them, such as the pressure exerted on them when a paint brush is being inserted into the paint or while the paint is being applied.

11. Liquid paint color in accordance with one of the above claims, characterized by the fact that the mass of scented oil (measured in grams) equals 1% to 10% of the glass paint volume (measured in millimeters).

12. Liquid paint color in accordance with one of the above claims, characterized by the fact that the mass of scented oil (measured in grams) equals 5% of the glass paint volume (measured in millimeters).

13. Liquid paint color in accordance with one of the above claims, characterized by the fact that it is polyurethane based.

14. Liquid paint color in accordance with one of the above claims, characterized by the fact that the color is green and that it smells like fir, pine needles or something similar.

15. Liquid paint color in accordance with one of the above claims, characterized by the fact that the color is brown and that it smells like cinnamon or cloves.

16. Liquid paint color in accordance with one of the above claims characterized by the fact that the color is orange and that it smells like mandarins.

17. Liquid paint color with plastic material based pigment whereby the pigment particle forms a matrix in which the selected scent can be stored in such a manner that it can be released.

18. Liquid paint color set with a least one of the paint colors described in one of claims 1 to 17.

19. Liquid paint color set in accordance with claim 18, characterized by the fact that the color and scent of the scented paint colors are chosen according to the theme, the product or the character on which the set is based.

20. Liquid paint color set in accordance with one of claims 17 to 19, characterized by the fact that theme, product or character based templates are included.
